(19) United States
(12) Patent Application Publication
(10) Pub. No.: US 2010/0005359 A1
(43) Pub. Date: Jan. 7, 2010

(54) COMMUNICATION APPARATUSES, TRANSMISSION METHOD, RECEIVING METHOD OF A WIRELESS NETWORK SYSTEM FOR HYBRID AUTOMATIC REPEAT REQUEST AND TANGIBLE MACHINE-READABLE MEDIUM THEREOF

(75) Inventors: Tsung-Yu Tsai, Shanhua Town (TW); Jiun-Je Jian, Taipei City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Institute for Information Industry, Taipei (TW)

(21) Appl. No.: 12/497,592

(22) Filed: Jul. 3, 2009

Related U.S. Application Data
(60) Provisional application No. 61/078,357, filed on Jul. 4, 2008.

(51) Int. Cl. H04L 1/18; G06F 11/14

(52) U.S. Cl. 714/749; 714/E11.113

(57) ABSTRACT

A communication apparatuses, a transmission method, a receiving method of a wireless network system for hybrid automatic repeat request (HARQ) and a tangible machine-readable medium thereof are provided. The wireless network system comprises a base station (BS) and at least one mobile station (MS). The transmission method comprises the following steps of: transmitting at least one first burst having a first symbol and a second symbol to the at least one MS; receiving at least one negative acknowledgement (NAK) from the at least one MS; generating a third symbol by proceeding a linear combination according to the first symbol and the second symbol of the at least one first burst; and transmitting at least one second burst having the third symbol to the at least one MS.

### CROSS-REFERENCES TO RELATED APPLICATIONS

This application claims the benefit of Provisional Application Ser. No. 61/078,357 filed on Jul. 4, 2008.

### BACKGROUND OF THE INVENTION

1. Field of the Invention

The present invention relates to a communication apparatuses, a transmission method, a receiving method of a wireless network system for hybrid automatic repeat request (HARQ) and a tangible machine-readable medium thereof. More specifically, the present invention relates to a communication apparatuses, a transmission method, a receiving method of a wireless network system for HARQ and a tangible machine-readable medium thereof which provide a retransmission scheme for saving bandwidth resource.

2. Descriptions of the Related Art

Although the IEEE 802.16 standard already provides greater bandwidths, lower building cost, better service quality and expansibility, there still exist some defects of coverage and signal quality of the IEEE 802.16 standard. After the International Telecommunications Union-Radiocommunication Sector (ITU-R) developed the International Mobile Telecommunications-Advanced (IMT-Advanced) air interface standardization, common technical, operational and spectrum-related parameters of systems will maximize the commonality between IMT-Advanced air interfaces. However, no existing IEEE 802 standards or projects can meet the IMT-Advanced target requirements nowadays, such as 100 Mbit/sec in high-speed mobility applications. Therefore, the IEEE 802.16m standard is developed like a raging fire to meet the IMT-Advanced target requirements by the IEEE 802.16 Working Group's Task Group m.

The HARQ, adopted in the IEEE 802.16 standard, is an advanced data retransmission strategy, which allows performing possible data retransmissions directly at the physical layer instead of the media access control (MAC) layer and/or higher layers. Since the HARQ is able to achieve data retransmission without involving mechanisms at the higher layers, the delay caused by data retransmission is significantly reduced. However, the original HARQ in the IEEE 802.16 standard fails to meet the IMT-Advanced target requirements.

FIG. 1A is a schematic diagram illustrated a wireless network system 1 with a chase combining (CC) HARQ scheme under the IEEE 802.16 standard. The wireless network system 1 comprises a base station (BS) 11 and a mobile station (MS) 13.

During a downlink period, the BS transmits a burst 101 (shown in FIG. 1B) comprising a cyclic redundancy check (CRC) C1 and a plurality of symbols (e.g. six symbols S1, S2, S3, S4, S5, S6). After the MS 13 receives the burst 101, it will check the burst 101 by the CRC C1. More specifically, the MS 13 will first determine whether the burst 101 can be decoded successfully or not by checking the CRC C1. If the burst 101 is successfully decoded, the MS 13 will feedback an acknowledgement ACK to the BS 11 and forward the decoded burst to an upper layer. Otherwise, the MS 13 will feedback a negative acknowledgement NAK to the BS 11. Upon receiving the negative acknowledgement NAK, the BS 11 will retransmit another burst which is the same as the burst 101 to the MS 13. The retransmission scheme will not stop until the BS 11 receives an acknowledgement ACK from the MS 13, retransmission time expires, or retry count exhausted, so that the error rate of the wireless network system 1 will drop.

However, as the number of the negative acknowledgement NAK increases, the wireless network system 1 has to spend more and more bandwidth resource to retransmit the same bursts, such as the burst 101. In other words, the wireless network system 1 will hold too much resource (e.g. symbols and bandwidth) to increase the throughput so that the spectrum efficiency and capacity of the wireless network system under the IEEE 802.16 standard are both low and thus fail to meet the IMT-Advanced target requirements.

Accordingly, how to reduce the error probability without over wasting resource of the wireless network system to meet the IMT-Advanced target requirements is still an objective for the industry to endeavor. In view of this, efforts still have to be made in the wireless communication industry to provide a solution to achieve transmission for HARQ under the IEEE 802.16 standard.

### SUMMARY OF THE INVENTION

The first objective of the present invention is to provide a communication apparatus of a wireless network system for HARQ. The wireless network system comprises at least one MS. The communication apparatus comprises a transmitting module, a receiving module and a processing module. The transmitting module is configured to transmit at least one first burst having a first symbol and a second symbol to the at least one MS. The receiving module is configured to receive at least one NAK from the at least one MS. The processing module is configured to generate a third symbol by proceeding a liner combination according to the first symbol and the second symbol of the at least one first burst. Finally, the transmitting module transmits at least one second burst having the third symbol to the at least one MS.

The second objective of the present invention is to provide another communication apparatus of a wireless network system for HARQ. The wireless network system comprises a BS. The communication apparatus comprises a transmitting module, a receiving module and a processing module. The receiving module is configured to receive at least one first burst having a first symbol and a second symbol from the BS. The processing module is configured to determine that the at least one first burst is incorrect. The transmitting module is configured to transmit at least one NAK to the BS after the processing module determines that the at least one first burst is incorrect. Then the receiving module receives at least one second burst having a third symbol, which is generated by proceeding a liner combination according to the first symbol and the second symbol of the at least one first burst, from the BS. Finally, the processing module estimates the first symbol and the second symbol according to the at least one first burst and the at least one second burst.

The third objective of the present invention is to provide a transmission method of a wireless network system for HARQ. The wireless network system comprises at least one MS. The transmission method comprises the step of: (a) transmitting at least one first burst having a first symbol and a second symbol to the at least one MS; (b) receiving at least one NAK from the at least one MS; (c) generating a third symbol by proceeding a liner combination according to the first symbol and the second symbol of the at least one first burst; and (d) transmitting at least one second burst having the third symbol to the at least one MS.

The fourth objective of the present invention is to provide a receiving method of a wireless network system for HARQ. The wireless network system comprises a BS. The receiving method comprises the step of: (a) receiving at least one first burst having a first symbol and a second symbol from the BS; (b) determining that the at least one first burst is incorrect; (c) transmitting at least one NAK to the BS after determining that the at least one first burst is incorrect; (d) receiving at least one second burst having a third symbol from the BS, wherein the third symbol is generated by proceeding a liner combination according to the first symbol and the second symbol of the at least one first burst via the BS; and (e) estimating the first symbol and the second symbol according to the at least one first burst and the at least one second burst.

This invention provides a tangible machine-readable medium storing a program which, when being executed, enables a communication apparatus to execute the transmission/receiving method of the wireless sensor network for HARQ described above.

Accordingly, the present invention can provide a retransmission scheme of saving bandwidth resource by transmitting half symbol number than that of the prior art. The spectrum efficient and system capacity therefore will be approved with low gain loss by appropriate decoding methods.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic diagram illustrating a conventional wireless network system with a chase combining HARQ scheme;

FIG. 1B is a schematic diagram illustrating a burst of the conventional wireless network system;

FIG. 2A is a schematic diagram illustrating the first embodiment in accordance with the present invention;

FIG. 2B is a schematic diagram illustrating bursts of the first embodiment;

FIG. 2C is a schematic diagram illustrating maximum gain combining decoding scheme of the first embodiment;

FIG. 3A is a flow chart of the second embodiment of the present invention; and

FIG. 3B is a flow chart of the third embodiment of the present invention.

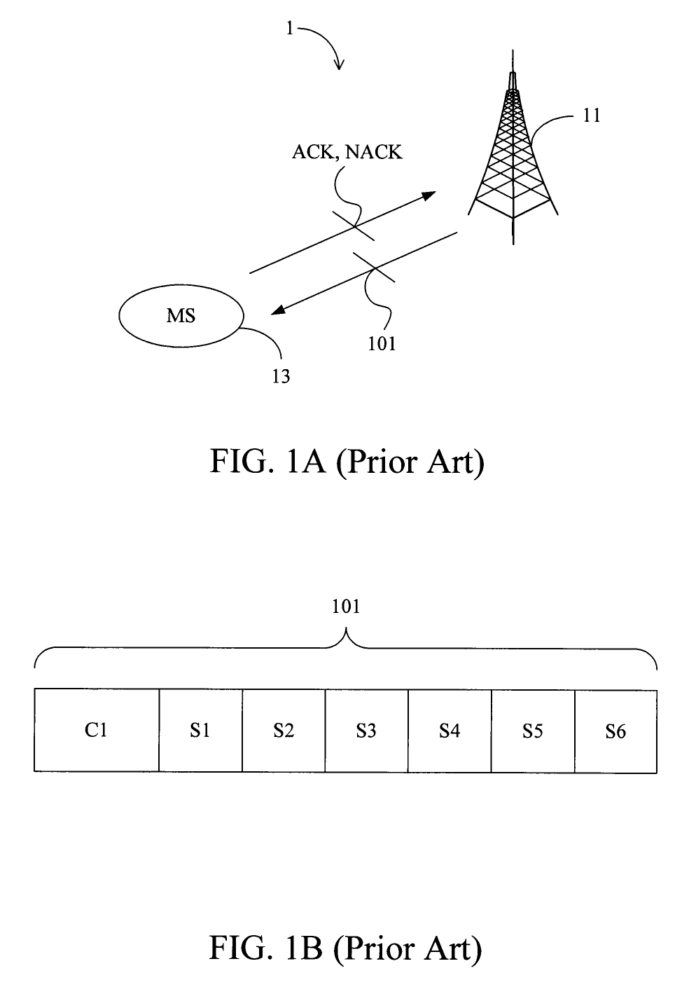

### DESCRIPTION OF THE PREFERRED EMBODIMENT

In the following description, the present invention will be explained with reference to embodiments thereof. However, the descriptions of these embodiments are only for purposes of illustration rather than limitations. It should be appreciated that in the following embodiments and the attached drawings, the elements not related directly to this invention are omitted from depiction and dimensional relationships among individual elements in the attached drawings are illustrated only for ease of understanding, and not limitation.

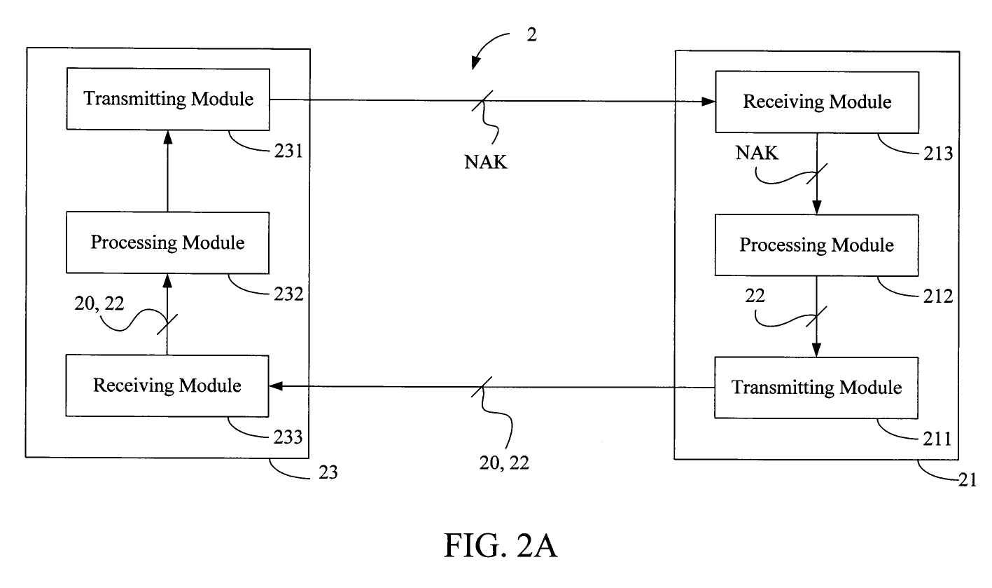

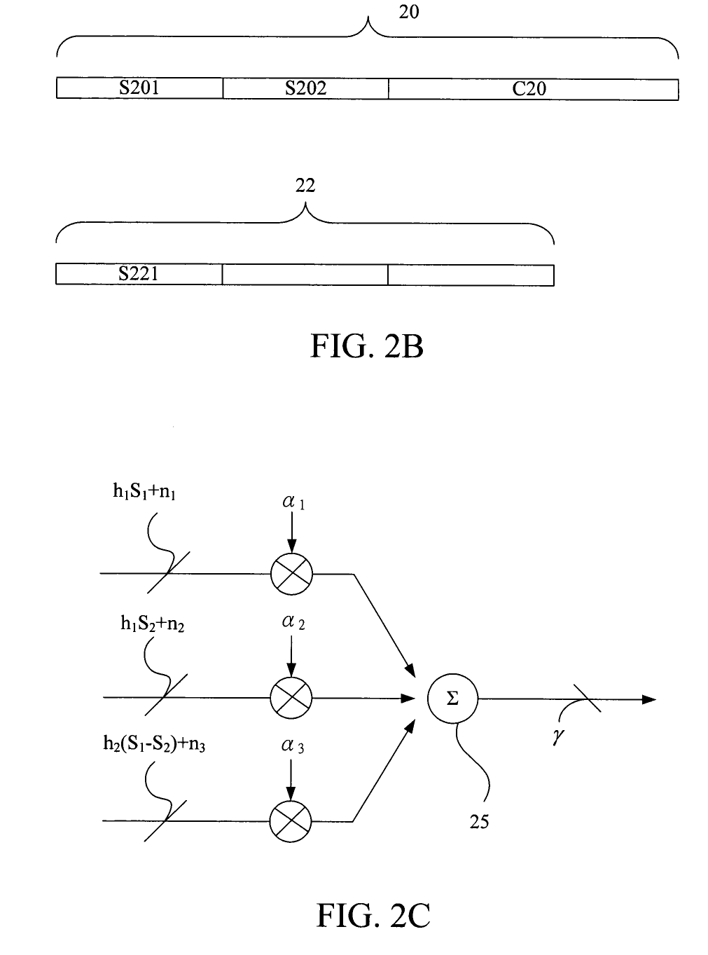

FIG. 2A illustrates a wireless network system 2 of a first embodiment under the IEEE 802.16 standard in accordance with the present invention, wherein the wireless network system 2 is with a symbol-level multiplexing HARQ retransmission scheme. The IEEE 802.16 standard can be any standard which will be developed in the future, such as the IEEE 802.16m standard.

The wireless network system 2 comprises a first communication apparatus, such as a BS 21 and at least one second communication apparatus, such as a MS 23. The BS 21 comprises a transmitting module 211, a processing module 212 and a receiving module 213. Similarly, the MS 23 comprises a transmitting module 231, a processing module 232 and a receiving module 233.

During a downlink period, the transmitting module 211 of the BS 21 initially transmits a first burst 20 (shown in FIG. 2B) to the MS 23, wherein the first burst 20 comprises a plurality of symbols and a CRC C20. For the sake of convenience, there are two symbols described in the first burst 20 (e.g. a first symbol S201 and a second symbol S202). After the receiving module 233 of the MS 23 receives the first burst 20, the processing module 232 of the MS 23 will determine whether the first burst 20 is incorrect or not. In other words, the processing module 232 will decode the first burst 20 according to the CRC C20. If the first burst 20 can be decoded successfully, the MS 23 will feedback an acknowledgement ACK to the BS 21 and forward the decoded burst to an upper layer. Otherwise, the transmitting module 231 of the MS 23 will transmit a negative acknowledgement NAK to the BS 21 after the processing module 232 determines that the first 20 is incorrect.

In the first embodiment, the receiving module 213 receives the negative acknowledgement NAK from the MS 23, and the processing module 212 of the BS 21 will generate a third symbol S221 (as shown in FIG. 2B) by proceeding a liner combination according to the first symbol S201 and the second symbol 202 of the first burst 20 (shown in FIG. 2B). Then the transmitting module 211 of the BS 21 transmits a second burst 22 having the third symbol S221 to the MS 23.

More specifically, the BS 21 will perform the linear combination function according to the first and the second symbols S201, S202 to generate the third symbol S221 before transmitting the second burst 22. The first and the second symbols S201, S202 may be adjacent or not adjacent, and in the embedment, the first and the second symbols S201, S202 are adjacent.

For example, the processing module 212 of the BS 21 may generate the third symbol S221 by performing a subtraction between the first symbol S201 and the second symbol S202 of the first burst 20. By the linear combination function, the symbol number of the second burst 22 is half than that of the first burst 20. In this embedment, the third symbol S221 is a subtraction between the first symbol S201 and the second symbol S202 of the first burst 20.

It should be noted that the symbol number of the second burst 22 ought to depend on that of the first burst 20. For example, if the first burst 20 comprises six symbols, i.e. the 1^{st}, 2^{nd}, 3^{rd}, 4^{th}, 5^{th}, and 6^{th} symbol in order, the second burst 22 will then comprise three symbols by the BS 21 performing the linear combination function of the six symbols of the first burst 20. More specifically, the three symbols of the second burst 22 may be generated by the subtraction or an addition between the 1^{st} symbol and the 2^{nd} symbol of the first burst 20, the subtraction or the addition between the 3^{rd} symbol and the 4^{th} symbol of the first burst 20, and the subtraction or the addition between the 5^{th} symbol and the 6^{th} symbol of the first burst 20, respectively. Those skilled in the art can understand the corresponding operations of linear combination function of the BS 21 by the explanation of the above description, and thus more detailed explanation is unnecessary.

After the receiving module 233 of the MS 23 receives the second burst 22 having the third symbol S221, processing module 232 of the MS 23 will start to estimate the first and the second symbols S201, S202 according to the first burst 20 and the second burst 22. More specifically, although the processing module 232 can not decode the first burst 20 to retrieval the first and the second symbols S201, S202 successfully, it can still estimate the first and the second symbols S201, S202 according to the second burst 22. The estimation will be described as the following description.

When starting to estimate the first and the second symbols S201 and S202, the processing module 232 first obtains h₁S₁+h₁′S₂ by adding the first and the second symbols S201, S202 in the first burst 20, wherein S₁ represents the first symbol S201, S₂ represents the second symbol S202, and h₁ represents the channel response of S₁ and h₁ represents the channel response of S₂ in the transmission of the first burst 20. The processing module 232 further obtains h₂S₁−h₂S₂ according to the third symbol S221 in the second burst 22, wherein h₂ represents the channel response of the third symbol S221 in the transmission of the second burst 22. Note that channel responses h₁, h₁′ and h₂ may be obtained by arbitrary channel estimation techniques. Since the first and the second symbols S201 and S202 are two adjacent symbols, for simplified the derivation, it is reasonable to regard that their channel responses are approximately the same, which means h₁=h₁′. However, the decoding methods described below will also applicable without this constraint.

The equation (1) shows the combining for the h₁S₁+h₁S₂ and h₂S₁−h₂S₂:

$$X = [ \begin{matrix}{x}_{1} \\ {x}_{2}\end{matrix} ] \\ = [ \begin{matrix}{h}_{1} {S}_{1} + {h}_{1} {S}_{2} \\ {h}_{2} {S}_{1} - {h}_{2} {S}_{2}\end{matrix} ] \\ = [ \begin{matrix}{h}_{1} & {h}_{1} \\ {h}_{2} & - {h}_{2}\end{matrix} ] [ \begin{matrix}{S}_{1} \\ {S}_{2}\end{matrix} ] + [ \begin{matrix}{n}_{1} + {n}_{2} \\ {n}_{3}\end{matrix} ] \\ = HS + N \qquad ( 1 )$$

Wherein n₁+n₂ represents a noise part of the transmission of the first burst 20, n₃ represents a noise part of the transmission of the second burst 22, H represents a matrix related to the gain, S represents a matrix related to the first and the second bursts 20, 22, and N represents a matrix related to noise.

There are some approaches, which are described as the following description, for the processing module 232 to estimate S₁ (i.e. the first symbol S201) and S₂ (i.e. the second symbol S202) according to the equation (1).

Approach 1: Maximum Likelihood (ML)

One alternative approach is using Maximum Likelihood according to the following equation:

$$\hat{S} = {arg}_{S} min ‖ X - HS ‖$$

S₁ (i.e. the first symbol S201) and S₂ (i.e. the second symbol S202) can be estimated such that the term of ∥X−HS∥ has a minimum value. The ML is a well-known method in the prior art, and the details will not be mentions here.

Approach 2: QR Decomposition

By using QR decomposition method, the matrix H will be decomposed into the multiplication of the matrix Q and the matrix R according to the equation (2):

$$X = [ \begin{matrix}{x}_{1} \\ {x}_{2}\end{matrix} ] \\ = [ \begin{matrix}{h}_{1} {S}_{1} + {h}_{1} {S}_{2} \\ {h}_{2} {S}_{1} - {h}_{2} {S}_{2}\end{matrix} ] \\ = [ \begin{matrix}{h}_{1} & {h}_{1} \\ {h}_{2} & - {h}_{2}\end{matrix} ] [ \begin{matrix}{S}_{1} \\ {S}_{2}\end{matrix} ] + N \\ = HS + N + QRS + N \qquad ( 2 )$$

The matrix Q is a unitary matrix as shown in the following equation:

$$Q = [ \begin{matrix}\frac{{h}_{1}}{\sqrt{{\vert {h}_{1} \vert}^{2} + {\vert {h}_{2} \vert}^{2}}} & \frac{\vert {h}_{2} \vert {h}_{1}}{\vert {h}_{1} \vert \sqrt{{\vert {h}_{1} \vert}^{2} + {\vert {h}_{2} \vert}^{2}}} \\ \frac{{h}_{2}}{\sqrt{{\vert {h}_{1} \vert}^{2} + {\vert {h}_{2} \vert}^{2}}} & \frac{- \vert {h}_{1} \vert {h}_{2}}{\vert {h}_{2} \vert \sqrt{{\vert {h}_{1} \vert}^{2} + {\vert {h}_{2} \vert}^{2}}}\end{matrix} ]$$

The matrix R is an upper triangular matrix as shown in the following equation:

$$R = [ \begin{matrix}\sqrt{{\vert {h}_{1} \vert}^{2} + {\vert {h}_{2} \vert}^{2}} & \frac{{\vert {h}_{1} \vert}^{2} - {\vert {h}_{2} \vert}^{2}}{\sqrt{{\vert {h}_{1} \vert}^{2} + {\vert {h}_{2} \vert}^{2}}} \\ 0 & \sqrt{{\vert {h}_{1} \vert}^{2} + {\vert {h}_{2} \vert}^{2} - \frac{{( {\vert {h}_{1} \vert}^{2} - {\vert {h}_{2} \vert}^{2} )}^{2}}{{\vert {h}_{1} \vert}^{2} + {\vert {h}_{2} \vert}^{2}}}\end{matrix} ]$$

After canceling the matrix Q by multiplying Q^{H} at the front of H, the equation (2) is modified as the following equation:

$$\begin{matrix}{Q}^{H} X = RS + {N}^{′} \\ = [ \begin{matrix}\sqrt{{\vert {h}_{1} \vert}^{2} + {\vert {h}_{2} \vert}^{2}} & \frac{{\vert {h}_{1} \vert}^{2} - {\vert {h}_{2} \vert}^{2}}{\sqrt{{\vert {h}_{1} \vert}^{2} + {\vert {h}_{2} \vert}^{2}}} \\ 0 & \sqrt{{\vert {h}_{1} \vert}^{2} + {\vert {h}_{2} \vert}^{2} - \frac{{( {\vert {h}_{1} \vert}^{2} - {\vert {h}_{2} \vert}^{2} )}^{2}}{{\vert {h}_{1} \vert}^{2} + {\vert {h}_{2} \vert}^{2}}}\end{matrix} ] \\ [ \begin{matrix}{S}_{1} \\ {S}_{2}\end{matrix} ] + {N}^{′}\end{matrix}$$

wherein N′ is the result of N multiplied by Q^{H}.

According to the property of the upper triangular matrix R, there will be no interference term for S₂ (i.e. the second symbol S202). Thus S₂ (i.e. the second symbol S202) can be estimated, and the gain of S₂ equals to

$$\sqrt{{\vert {h}_{1} \vert}^{2} + {\vert {h}_{2} \vert}^{2} - \frac{{( {\vert {h}_{1} \vert}^{2} - {\vert {h}_{2} \vert}^{2} )}^{2}}{{\vert {h}_{1} \vert}^{2} + {\vert {h}_{2} \vert}^{2}}} .$$

After S₂ (i.e. the second symbol S202) is decoded, S₁ (i.e. the first symbol S201) can be also estimated by applying the same QR decomposition approach. Those skilled in the art can understand the corresponding approach of decoding S₁ (i.e. the first symbol S201) by the explanation of the above description, and thus more detailed explanation is unnecessary.

Approach 3: Sphere Decoding Algorithm

Sphere detection algorithm (SDA) is another common approach, which is near-optimal by adjusting radius of search, to estimate S₁ (i.e. the first symbol S201) and S₂ (i.e. the second symbol S202) with lower calculation complexity. The SDA is also a well-known method used in the prior art, so the details will not be mentioned here.

Approach 4: Maximum Gain Combining (MGC)

Maximum Gain Combining approach can also provide near optimum performance with considerably lower complexity by linearly combining S₁, S₂, and S₁-S₂ (i.e. the first, the second and the third symbols S201, S202, S221) with different coefficients in order to achieve a maximum gain. Essentially, it is a generalized approach since linear decoding methods mentioned above could be modified to special cases of linear combining. Please refer to FIG. 2C, which is a schematic diagram illustrated a model of the maximum ratio combining decoding scheme of the first embodiment.

For the MGC approach, the processing module 232 will estimate one symbol and eliminate other symbols. For example, the processing module 232 may estimate S₁ (i.e. the first symbol S201) or S₂ (i.e. the second symbol S202) by maxing a gain of S₁ (i.e. the first symbol S201) and eliminating S₂ (i.e. the second symbol S202) of the first burst 20, and estimate S₂ (i.e. the second symbol S202) according to S₁ (i.e. the first symbol S201). For illustration of the decoding procedure, the following description takes S₁ (i.e. the first symbol 201) as an example. As shown in FIG. 2C, the S₁, S₂, S₁-S₂ (i.e. the first, second, third symbols S201, S202, S221) are linearly combined by different coefficients α₁, α₂, and α₃. Note that the coefficients can be real number or complex numbers. After the combination, the output of the combiner 25 is (α₁h₁+α₃h₂)S₁+(α₁h₁−α₃h₂)S₂+\sqrt{(|α₁|²+|α₂|²+|α₃|²)}n′, wherein n′ has a normal distribution whose mean is zero and variance is σ.

More specifically, the SINR of S₁ (denoted as γ_{S}_{₁}) can be represented as the equation (3):

$${γ}_{{s}_{1}} = \frac{{( {α}_{1} {h}_{1} + {α}_{3} {h}_{2} )}^{2} {A}^{2}}{{( {α}_{2} {h}_{1} - {α}_{3} {h}_{2} )}^{2} {A}^{2} + ( {\vert {α}_{1} \vert}^{2} + {\vert {α}_{2} \vert}^{2} + {\vert {α}_{3} \vert}^{2} ) σ} \\ = \frac{{( {α}_{1} {h}_{1} + {α}_{3} {h}_{2} )}^{2} SNR}{{( {α}_{2} {h}_{1} - {α}_{3} {h}_{2} )}^{2} SNR + ( {\vert {α}_{1} \vert}^{2} + {\vert {α}_{2} \vert}^{2} + {\vert {α}_{3} \vert}^{2} )} \qquad ( 3 )$$

Wherein A represents the amplitude of S₁ (i.e. the first symbol S201) and S₂ (i.e. the second symbol S202) which are assumed to be the same, SNR is defined as

$$\frac{{A}^{2}}{σ} .$$

There are two observations on the equation (3) to find the set of coefficients α₁, α₂ and α₃.

Observation 1:

$${α}_{1} = \frac{{h}_{1}^{*} {α}_{3}}{{h}_{2}^{*}} .$$

This relationship can be proved by applying Cauchy-Schwartz inequality to the numerator of the equation (3). The Cauchy-Schwartz inequality is a well-known to the people skilled in this art, the details will not be mentioned here.

Observation 2:

To make the term (α₂h₁−α₃h₂)² in denominator of the equation (3) as small as possible, such as ∠α₂h₁=∠α₃h₂→∠α₂=∠α₃+∠h₂−∠h₁. Thus the relationship of phases of α₂ and α₃ are known, then |α₂| can further represents as x|α₃|, where xε [symbol] .

From observation 1 and 2, the equation (3) can be modified as the equation (4):

$${γ}_{{s}_{1}} = \frac{{( \frac{{h}_{1}^{*} {h}_{1}}{{h}_{2}^{*}} {α}_{3} + {h}_{2} {α}_{3} )}^{2} SNR}{\begin{matrix}( {x}^{2} {\vert {h}_{1} \vert}^{2} - 2 x \vert {h}_{1} \vert \vert {h}_{2} \vert + {\vert {h}_{2} \vert}^{2} ) SNR + \\ ( {\vert {α}_{1} \vert}^{2} + {\vert {α}_{2} \vert}^{2} + {\vert {α}_{3} \vert}^{2} )\end{matrix}} \\ = \frac{\frac{{( {\vert {h}_{1} \vert}^{2} + {\vert {h}_{2} \vert}^{2} )}^{2}}{{\vert {h}_{2} \vert}^{2}} {\vert {α}_{3} \vert}^{2} SNR}{\begin{matrix}( {x}^{2} {\vert {h}_{1} \vert}^{2} - 2 x \vert {h}_{1} \vert \vert {h}_{2} \vert + {\vert {h}_{2} \vert}^{2} ) {\vert {α}_{3} \vert}^{2} SNR + \\ ( {\vert {α}_{1} \vert}^{2} + {\vert {α}_{2} \vert}^{2} + {\vert {α}_{3} \vert}^{2} )\end{matrix}} \qquad ( 4 )$$

Wherein |α₁|²+|α₂|²+|α₃|²=K, by knowing

$${\vert {α}_{1} \vert}^{2} = \frac{{\vert {h}_{1} \vert}^{2}}{{\vert {h}_{2} \vert}^{2}} {\vert {α}_{3} \vert}^{2} and {\vert {α}_{2} \vert}^{2} = {x}^{2} {\vert {α}_{3} \vert}^{2} ,$$

|α₃|² represents as

$$\frac{{\vert {h}_{2} \vert}^{2} K}{{\vert {h}_{1} \vert}^{2} + ( 1 + {x}^{2} ) {\vert {h}_{2} \vert}^{2}} .$$

According to the above terms, the equation (4) can be obtained as the following equation:

$$\begin{matrix}{γ}_{{s}_{1}} = \frac{\frac{{( {\vert {h}_{1} \vert}^{2} + {\vert {h}_{2} \vert}^{2} )}^{2}}{{\vert {h}_{2} \vert}^{2}} * \frac{{\vert {h}_{2} \vert}^{2} K}{{\vert {h}_{1} \vert}^{2} + ( 1 + {x}^{2} ) {\vert {h}_{2} \vert}^{2}} SNR}{( {x}^{2} {\vert {h}_{1} \vert}^{2} - 2 x \vert {h}_{1} \vert \vert {h}_{2} \vert + {\vert {h}_{2} \vert}^{2} ) \frac{{\vert {h}_{2} \vert}^{2} K}{{\vert {h}_{1} \vert}^{2} + ( 1 + {x}^{2} ) {\vert {h}_{2} \vert}^{2}} SNR + K} \\ = \frac{{( {\vert {h}_{1} \vert}^{2} + {\vert {h}_{2} \vert}^{2} )}^{2} SNR * K}{( {x}^{2} {\vert {h}_{1} \vert}^{2} - 2 x \vert {h}_{1} \vert \vert {h}_{2} \vert + {\vert {h}_{2} \vert}^{2} ) {\vert {h}_{2} \vert}^{2} K * SNR + K ( {\vert {h}_{1} \vert}^{2} + ( 1 + {x}^{2} ) {\vert {h}_{2} \vert}^{2} )} \\ = \frac{{( {\vert {h}_{1} \vert}^{2} + {\vert {h}_{2} \vert}^{2} )}^{2} * SNR}{\begin{matrix}( SNR {\vert {h}_{1} \vert}^{2} {\vert {h}_{2} \vert}^{2} + {\vert {h}_{2} \vert}^{2} ) {\{ x - \frac{\vert {h}_{1} \vert {\vert {h}_{2} \vert}^{3} SNR}{{\vert {h}_{1} \vert}^{2} {\vert {h}_{2} \vert}^{2} SNR + {\vert {h}_{2} \vert}^{2}} \}}^{2} - \\ \frac{{\vert {h}_{1} \vert}^{2} {\vert {h}_{2} \vert}^{6} {SNR}^{2}}{{\vert {h}_{1} \vert}^{2} {\vert {h}_{2} \vert}^{2} SNR + {\vert {h}_{2} \vert}^{2}} + \frac{{\vert {h}_{1} \vert}^{2} {\vert {h}_{2} \vert}^{4}}{{\vert {h}_{1} \vert}^{2}} SNR + {\vert {h}_{1} \vert}^{2} + {\vert {h}_{2} \vert}^{2}\end{matrix}}\end{matrix}$$

The left most term in the dominator of the above equation should be zero for obtaining a maximum SINR.

In other words,

$$x = \frac{\vert {h}_{1} \vert {\vert {h}_{2} \vert}^{3} SNR}{{\vert {h}_{1} \vert}^{2} {\vert {h}_{2} \vert}^{2} SNR + {\vert {h}_{2} \vert}^{2}} , for , SNR >> {\vert {h}_{2} \vert}^{2} , x \approx \frac{\vert {h}_{2} \vert}{\vert {h}_{1} \vert} ,$$

and γₛ_{₁}≈(|h₁|²+h₁|²)SNR, which has the same gain as CC. Consequently, the coefficient α₁, α₂, α₃, which maximize the SINR of S₁ (i.e. the first symbol S201) should have the following relationship:

$${α}_{1} = \frac{{h}_{1}^{*}}{{h}_{2}^{*}} {α}_{3} , x * {α}_{3} \approx \frac{\vert {h}_{2} \vert}{\vert {h}_{1} \vert} {α}_{3} * {e}^{j ( ∠ {h}_{2} - ∠ {h}_{1} )}$$

|α₁|²+|α₂|²+|α₃|²=K, wherein K is an arbitrary positive value.

Those skilled in the art can understand the corresponding approach of decoding S₂ (i.e. the second symbol S202) by the explanation of the above description, and thus more detailed description is unnecessary.

In brief, the MGC will set α₁+α₂+α₃=K, wherein the K is a fixed value, and eliminate other symbols, e.g. set |α₁∥h₁−|α₃∥h₃|=0 to eliminate S₂ (i.e. the second symbol S202), so the processing module 232 can estimate S₁ (i.e. the first symbol S201) according to the two set conditions to max the gain of S₁ (i.e. the first symbol S201), i.e. |α₁∥h₁+|α₃∥h₂|.

Approach 5: Cross Feedback

In this approach, S₁ (i.e. the first symbol S201) and S₂ (i.e. the second symbol S202) may be first decoded by some algorithms (e.g. one of the above approaches 1˜4), then the decoding result of S₁ and S₂ will be feedback to other symbols. According to the feedback of other symbols, a symbol could have another decoding result by using decision feedback (a.k.a. interference cancellation). Thus each symbol has a pair of decoding results. The processing module 232 may adopt a decision criteria to make a final decision for the values of S₁ (i.e. the first symbol S201) and S₂ (i.e. the second symbol S202).

For example, if the processing module 232 estimates S₁ (i.e. the first symbol S201) to be X by MGC approach, then the processing module 232 can obtain S₂ (i.e. the second symbol S202) to be Y according to the equation (1) and X (i.e. the estimated S₁). Next, the processing module 232 estimates S₂ (i.e. the second symbol S202) to be X′ by MGC approach, then the processing module 232 can obtain S₁ (i.e. the first symbol S201) to be Y′ according to the equation (1) and Y′ (i.e. the estimated S₂). The processing module 232 will obtain a pair estimated result of the S₁, i.e. (X, X′), and a pair estimated result of S₂, i.e. (Y, Y′).

The processing module 232 will make a final decision for the values of S₁ (i.e. the first symbol S201) and S₂ (i.e. the second symbol S202) according to the two pair (X, X′) and (Y, Y′) based on the decision criteria. The decision criteria can be determined according to wireless channel status, used modulation, empirical adjustment, etc.

Preferably, if one of the two pairs is matched, but the other pair is not matched, the processing module 232 will adopt the pair which the result is matched. Oppositely, when the pair is not matched, the processing module 232 will adopt the result of decision feedback. For example, if X=X′ and Y≠Y′, the processing module 232 will adopt S₁ (i.e. the first symbol S201) to be X and adopt S₂ (i.e. the second symbol S202) to be Y′.

If the two pairs are not matched, the processing module 232 will adopt the pair with a larger gain, and for the other pair, adopt the result of decision feedback. For example, if X≠X′, Y≠Y′ and a gain of (X, X′) is larger than a gain of (Y, Y′), the processing module 232 adopt S₁ (i.e. the first symbol S201) to be X and adopt S₂ (i.e. the second symbol S202) to be Y′.

If both of the two pairs are matched, the processing module 232 will adopt the estimated results. For example, if X=X′ and Y=Y′, the processing module 232 adopt S₁ (i.e. the first symbol S201) to be X and adopt S₂ (i.e. the second symbol S202) to be Y.

It should be noted that above decision criteria is only for illustration, not to limit the present invention, people skilled in this art can design other decision criteria depend on the practical requirements.

The estimated approaches of the first embodiment are described as above. The processing module 232 will further determines whether the estimated S₁ (i.e. the first symbol S201) and S₂ the second symbol is correct or not according to the CRC C20. If the estimated symbols are correct, the MS 23 will feedback a acknowledgement to the BS 21, otherwise, the MS 23 will feedback a negative acknowledge to the BS 21 and continues the above steps.

The following descriptions are to illustration other embodiments that can also be applied the above estimated approach.

In the first embodiments, the processing module 212 generates the third symbol S221 by performing a subtraction, for other embodiments, the processing module 212 can shift a first predetermined phase for S₁ (i.e. the first symbol S201), shift a second predetermined phase for S₂ (i.e. the second symbol S202), and then generates the third symbol S221 by proceeding the linear combination of the shifted S₁ (i.e. the shifted first symbol) and the shifted S₂ (i.e. the shifted second symbol).

For example, the processing module 212 shifts S₁ (i.e. the first symbol S201) and S₂ (i.e. the second symbol S202) a phase θ in opposite directions, wherein the shifted phase θ is a predetermined value and known by both the BS 21 and the MS 23. Then, the processing module 212 generates the third symbol S203 by linear combination function of the shifted S₁ (i.e. the shifted first symbol) and shifted S₂ (i.e. the shifted second symbol), e.g. e^{-jθ}S₁−e^{jθ}S₂. It should be noted that the first embodiment can be regarded a special case of the above method with the shifted phase θ equal to zero.

Accordingly, the equation (2) may be modified as the following equation:

$${X}^{′} = [ \begin{matrix}{h}_{1} & {h}_{1} \\ {h}_{2} {e}^{- jθ} & - {e}^{jθ} {h}_{2}\end{matrix} ] [ \begin{matrix}{S}_{1} \\ {S}_{2}\end{matrix} ] + N \\ = [ \begin{matrix}{e}^{jθ} {h}_{1} & {h}_{1} \\ {h}_{2} & - {e}^{jθ} {h}_{2}\end{matrix} ] [ \begin{matrix}{e}^{- jθ} {S}_{1} \\ {S}_{2}\end{matrix} ] + N \\ = HS + N \\ = QRS + N \qquad ( 5 )$$

The matrix Q is a unitary matrix as shown in the following equation:

$$Q = [ \begin{matrix}\frac{{h}_{1}}{\sqrt{{\vert {h}_{1} \vert}^{2} + {\vert {h}_{2} \vert}^{2}}} … \\ \frac{{h}_{2} {e}^{- jθ}}{\sqrt{{\vert {h}_{1} \vert}^{2} + {\vert {h}_{2} \vert}^{2}}} …\end{matrix} ]$$

The matrix R is an upper triangular matrix as shown in the following equation:

$$R = [ \begin{matrix}{\vert {h}_{1} \vert}^{2} + {\vert {h}_{2} \vert}^{2} & … \\ 0 & g\end{matrix} ]$$

People skilled in this art may rapidly estimate S₁ (i.e. the first symbol S201) and S₂ (the second symbol S202) according to equation (5) and above said approaches, the details will not be further mentioned here.

It should be mentioned that the gain of the HARQ retransmission scheme with shifting phase of symbols before performing the linear combination is the same as that of the HARQ retransmission scheme without shifting phase of symbols. Beyond that, the HARQ retransmission scheme with shifting phase of symbols can also mitigate the self-cancellation problem.

Table 1 is another example for the pre-shifting phase of symbols if there is more than one retransmission.

TABLE 1
the retransmission pattern

| | Symbol 1 | Symbol 2 | Symbol 3 | Symbol 4 |
|---|---|---|---|---|
| Original sub-burst | S₁ | S₂ | S₃ | S₄ |
| Odd Retransmitted | e^{-jθ} S₁ − e^{jθ} S₂ | e^{-jθ} S₃ − e^{jθ} S₄ | N/A | N/A |
| sub-burst | | | | |
| Even Retransmitted | e^{jθ} S₁ + e^{-jθ} S₂ | e^{jθ} S₃ + e^{-jθ} S₄ | N/A | N/A |
| sub-burst | | | | |

In still another embodiments, the at least one MS may comprise a plurality of MSs (e.g. MS1 and MS2). If the BS is set to be a broadcast mode, MS1 and MS2 are able to receive the at least one first burst meant to transmit to each other. In other words, if the BS transmits a first burst to one of the MSs, the other MS can also receive it. Similarly, if the BS received at least one negative acknowledgement from the MSs, the BS will also generate at least one second burst according to the at least one first burst.

For example, S₁¹ and S₂¹ represent two symbols of the first burst meant to send to the MS1, and S₁² and S₂² represent two symbols of the first burst meant to send to the MS2. If the MS1 is able to decode S₁² and S₂² successfully but fails to decode S₁¹ and S₂¹, and the MS2 is able to decode S₁¹ and S₂¹ successfully but fails to decode S₁² and S₂², the BS will receive two negative acknowledgements form MS1 and MS2.

After receiving the negative acknowledgements from MS1 and MS2, similarly, the BS may generate at least one second burst according to S₁², S₂², S₁¹ and S₂¹, e.g. the second burst having symbols of S₁¹+S₁² and S₂¹+S₂², or the second burst having symbols of e^{-jθ}S₁¹−e^{jθ}S₁² and e^{-jθ}S₂¹−e^{jθ}S₂². The BS will transmit the second burst to the MS1 and the MS2.

Next, the MS1 and MS2 may estimate their symbols (i.e. the MS1 estimates S₁¹ and S₂¹ and the MS2 estimates S₁² and S₂²) according to the second burst and the above approaches individually. Then, for the MS1, since it has decoded S₁² and S₂² successfully, thus it can simply cancel the interference term of the second burst to obtain S₁¹ and S₂¹, for the MS2, since it has decoded S₁¹ and S₂¹ successfully, thus it can simply cancel the interference term of the second burst to obtain S₁² and S₂². Those skilled in the art can understand the corresponding approach of estimation of the symbols S₁², S₂², S₁¹ and S₂¹. by the explanation of the above description, and thus no necessary detail is given.

Table 2 is another example of the retransmission pattern for the MS1 and the MS2 if there is more than one retransmission.

TABLE 2
the retransmission pattern

| | Symbol 1 | Symbol 2 | Symbol 3 | Symbol 4 |
|---|---|---|---|---|
| Original sub-burst | S₁¹ (S₁²) | S₁² (S₂²) | S₃¹ (S₃²) | S₄¹ (S₄²) |
| Odd Retransmitted | e^{-jθ} S₁¹ − e^{jθ} S₁² | e^{jθ} S₂¹ − e^{jθ} S₂² | e^{-jθ} S₃¹ − e^{jθ} S₃² | e^{-jθ} S₄¹ − e^{jθ} S₄² |
| sub-burst | | | | |
| Even Retransmitted | e^{jθ}S₁¹ + e^{-jθ} S₁² | e^{jθ} S₁¹ + e^{-jθ} S₁² | e^{jθ} S₁¹ + e^{-jθ} S₁² | e^{jθ} S₁¹ + e^{-jθ} S₁² |
| sub-burst | | | | |

It should be noted that the first embodiment of the present invention can be adopted in both uplink and downlink. However, to be simplified, the first embodiment only illustrates the downlink case, since those skilled in this art can understand the corresponding operation of the present invention for the uplink case after the above description.

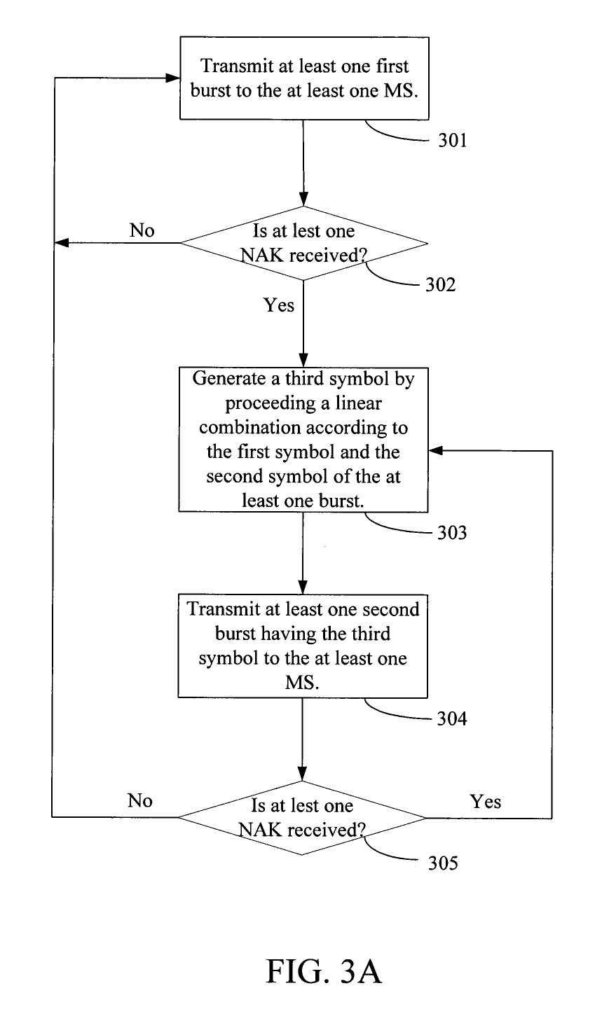

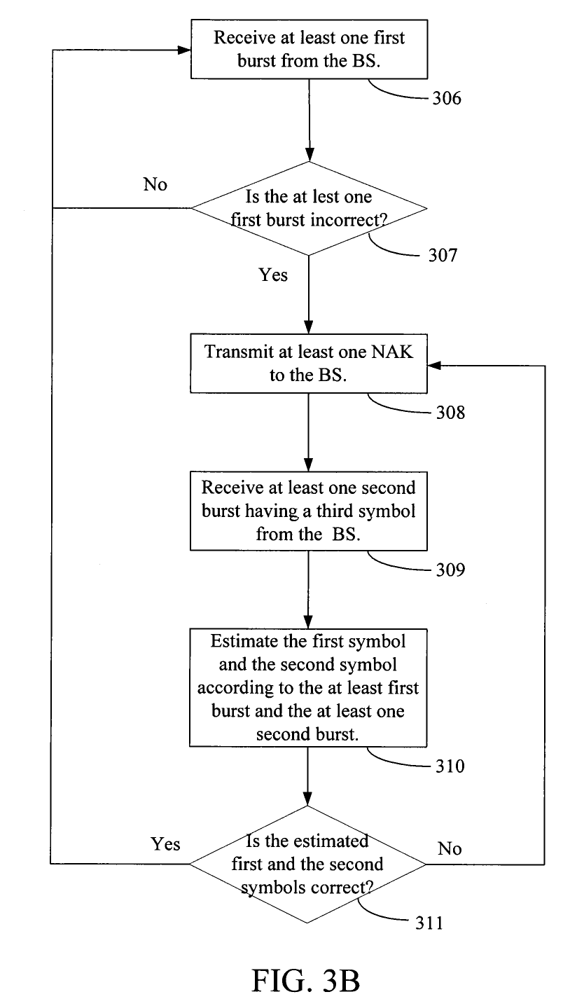

The second embodiment in accordance with the present invention shown in FIG. 3A is a transmission method of a wireless network system for HARQ, wherein the wireless network comprises at least one MS, e.g. the MS 23 described in the first embodiment. More specifically, the transmission method of the second embodiment can be implemented by a computer program product. The computer program product can be stored in a tangible machine-readable medium, such as a floppy disk, a hard disk, an optical disc, a flash disk, a tape, a database accessible from a network or any other storage media with the same functionality that can be easily thought by those skilled in the art.

Initially, in step 301, at least one first burst having a first symbol and a second symbol is transmitted to the at least one MS. Then, it is determined whether at least one negative acknowledgement is received from the at least one MS via step 302. If there is no negative acknowledgement received in step 302, the transmission method will go back to step 301 to transmit another first burst.

If there is a negative acknowledgement received in step 302, the transmission method proceeds to step 303, a third symbol is generated by proceeding a liner combination according to the first symbol and the second symbol of the at least one first burst.

The third symbol can be generated by performing a subtraction between the first symbol and the second symbol of the at least one first burst. Or, the transmission method shifts a first predetermined phase for the first symbol, shifts a second predetermined phase for the second symbol, and then generates the third symbol by proceeding the liner combination of the shifted first symbol and the shifted second symbol. The details about how to generate the third symbol are already described in the first embodiment, so the details will not be mentioned here.

Then, at least one second burst having third symbol is transmitted to the at least one MS in step 304. In step 305, it is determined that whether at least one negative acknowledgement is received. If there is no negative acknowledgement received in step 305, the transmission proceeds to step 301 to transmit another first burst. If there is at least one negative acknowledgement received in step 305, the transmission method proceeds to step 303 to generate another third symbol according to the above descriptions.

The third embodiment in accordance with the present invention shown in FIG. 3B is a receiving method of a wireless network system for HARQ, wherein the wireless network comprises a BS, e.g. the BS 21 described in the first embodiments. More specifically, the receiving method of the third embodiment can be implemented by a computer program product. The computer program product can be stored in a tangible machine-readable medium, such as a floppy disk, a hard disk, an optical disc, a flash disk, a tape, a database accessible from a network or any other storage media with the same functionality that can be easily thought by those skilled in the art.

Initially, in step 306, at least one first burst having a first symbol and a second symbol is received from the BS. It is determined whether the at least one first burst is incorrect in step 307, wherein the at least one first burst further comprises a CRC and the at least one NAK is performed according to the CRC. The details of how to determine the at least one first burst is incorrect is described in the first embodiment and will not be mentioned here.

If the at least one first burst is determined to be not incorrect, the receiving method will go back to step 306 to receive another first burst. If the at least one first burst is determined to be incorrect in step 307, at least one NAK is transmitted to the BS after determining that the at least one first burst is incorrect in step 308. Then, in step 309, at least one second burst having a third symbol is received from the BS, wherein the third symbol is generated by proceeding a liner combination according to the first symbol and the second symbol of the at least one first burst.

The first symbol and the second symbol are estimated according to the at least one first burst and the at least one second burst via step 310. For example, the first symbol and the second symbol are estimated by performing via a QR decomposition. Or, the first symbol is estimated by maxing a gain of the first symbol and eliminating the second symbol of the at least one first burst, and a second symbol is estimated according to the first symbol. The details about how to estimate first symbol and the second symbol are described in the first embodiment and will not be mentioned here. Finally, it is determined whether the estimated first symbol and the second symbol are correct according to the CRC. If the estimated first symbol and the second symbol is correct in step 311, the receiving method proceeds to step 306, otherwise, the receiving method proceeds to step 308.

Accordingly, the present invention can provide a retransmission scheme of saving bandwidth resource by transmitting half symbol number than that of the prior art. The spectrum efficient and system capacity therefore will be approved with low gain loss by appropriate decoding methods. Also, the pre-code algorithm does not need high complexity and the close gain can be maintained compared with the gain of CC.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered within the scope of the theory and spirit of the present invention.

What is claimed is:

1. A transmission method of a wireless network system for hybrid automatic repeat request (HARQ), the wireless network system comprising at lest one mobile station (MS), the transmission method comprising the steps of:
transmitting at least one first burst having a first symbol and a second symbol to the at least one MS;
receiving at least one negative acknowledgement (NAK) from the at least one MS;
generating a third symbol by proceeding a liner combination according to the first symbol and the second symbol of the at least one first burst; and
transmitting at least one second burst having the third symbol to the at least one MS.

2. The transmission method of claim 1, wherein the step of generating the third symbol further comprises the step of:
performing a subtraction between the first symbol and the second symbol of the at least one first burst.

3. The transmission method of claim 1, wherein the step of generating the third symbol further comprises the steps of:
shifting a first predetermined phase for the first symbol; and
shifting a second predetermined phase for the second symbol;
wherein the third symbol is generated by proceeding the liner combination of the shifted first symbol and the shifted second symbol.

4. A receiving method of a wireless network system for HARQ, the wireless network system comprising a base station (BS), the receiving method comprising the steps of:
receiving at least one first burst having a first symbol and a second symbol from the BS;
determining that the at least one first burst is incorrect;
transmitting at least one NAK to the BS after determining that the at least one first burst is incorrect;
receiving at least one second burst having a third symbol from the BS, wherein the third symbol is generated by proceeding a liner combination according to the first symbol and the second symbol of the at least one first burst via the BS; and
estimating the first symbol and the second symbol according to the at least one first burst and the at least one second burst.

5. The receiving method of claim 4, wherein the at least one first burst further comprises a cyclic redundancy code (CRC), the step of transmitting the at least one NAK is performed according to the CRC.

6. The receiving method of claim 4, wherein the step of estimating the first symbol and the second symbol is performed via a QR decomposition.

7. A communication apparatus of a wireless network system for HARQ, the wireless network system comprising at lest one MS, the communication apparatus comprising:
a transmitting module being configured to transmit at least one first burst having a first symbol and a second symbol to the at least one MS;
a receiving module being configured to receive at least one NAK from the at least one MS; and
a processing module being configured to generate a third symbol by proceeding a liner combination according to the first symbol and the second symbol of the at least one first burst;
wherein the transmitting module transmits at least one second burst having the third symbol to the at least one MS.

8. The communication apparatus of claim 7, wherein the processing module generates the third symbol by performing a subtraction between the first symbol and the second symbol of the at least one first burst.

9. The communication apparatus of claim 7, wherein the processing module shifts a first predetermined phase for the first symbol, shifts a second predetermined phase for the second symbol, and generates the third symbol by proceeding the liner combination of the shifted first symbol and the shifted second symbol.

10. A communication apparatus of a wireless network system for HARQ, the wireless network system comprising a BS, the communication apparatus comprising:
a receiving module being configured to receive at least one first burst having a first symbol and a second symbol from the BS;
a processing module being configured to determine that the at least one first burst is incorrect; and
a transmitting module being configured to transmit at least one NAK to the BS after the processing module determines that the at least one first burst is incorrect;
wherein the receiving module receives at least one second burst having a third symbol from the BS;
wherein the third symbol is generated by proceeding a liner combination according to the first symbol and the second symbol of the at least one first burst via the BS; and
wherein the processing module estimates the first symbol and the second symbol according to the at least one first burst and the at least one second burst.

11. The communication apparatus of claim 10, wherein the at least one first burst further has a CRC, the processing module determines that the at least one first burst is incorrect according to the CRC.

12. The communication apparatus of claim 10, wherein the processing module estimates the first symbol and the second symbol via a QR decomposition.

13. A tangible machine-readable medium storing a program of a transmission method of a wireless network system for HARQ, the wireless network system comprising at least one MS, the program comprising:
a code A for a transmitting module to transmit at least one first burst having a first symbol and a second symbol to the at least one MS;
a code B for a receiving module to receive at least one NAK from the at least one MS;
a code C for a processing module to generate a third symbol by proceeding a liner combination according to the first symbol and the second symbol of the at least one first burst; and
a code D for the transmitting module to transmit at least one second burst having the third symbol to the at least one MS.

14. The tangible machine-readable medium of claim 13, wherein code C further comprises:
a code C1 for processing module to perform a subtraction between the first symbol and the second symbol of the at least one first burst.

15. The tangible machine-readable medium of claim 13, wherein the code C further comprises:
a code C1 for the processing module to shift a first predetermined phase for the first symbol; and
a code C2 for the processing module to shift a second predetermined phase for the second symbol;
wherein the third symbol is generated by proceeding the liner combination of the shifted first symbol and the shifted second symbol.

16. A tangible machine-readable medium storing a program of a receiving method of a wireless network system for HARQ, the wireless network system comprising a BS, the program comprising:
a code A for a receiving module to receive at least one first burst having a first symbol and a second symbol from the BS;
a code B for a processing module to determine that the at least one first burst is incorrect;
a code C for a transmitting module to transmit at least one NAK to the BS after determining that the at least one first burst is incorrect;
a code D for receiving module to receive at least one second burst having a third symbol from the BS, wherein the third symbol is generated by proceeding a liner combination according to the first symbol and the second symbol of the at least one first burst via the BS; and
a code E for a processing module to estimate the first symbol and the second symbol according to the at least one first burst and the at least one second burst.

17. The tangible machine-readable medium of claim 16, wherein the at least one first burst further comprises a CRC, the code B further comprises:
a code B1 for the processing module to determine that the at least one first burst is incorrect according to the CRC.

18. The tangible machine-readable medium of claim 16, wherein the code E further comprises:
a code E1 for the processing module to estimate the first symbol and the second symbol via a QR decomposition.
